(19) United States
(12) Patent Application Publication
(10) Pub. No.: US 2021/0352837 A1
(43) Pub. Date: Nov. 18, 2021

(54) ALLEY VACUUM DUMPING RECEPTACLE FOR MANURE DILUTION WITH SAND GATES

(71) Applicant: Dari-Tech, Inc., Lynden, WA (US)

(72) Inventor: David DeWaard, Lynden, WA (US)

(21) Appl. No.: 15/930,757

(22) Filed: May 13, 2020

(51) Int. Cl. A01C 3/02; A01C 3/04; B01F 15/00

(52) U.S. Cl. CPC A01C 3/026; A01C 3/021; B01F 2215/0003; B01F 15/00331; A01C 3/04

(57) ABSTRACT

An apparatus and a method for receiving sand-laden manure from a vacuum truck in a duty cycle begins by collecting water issuing through a flume valve in a mixing basin. The mixing basin includes a metering bulkhead which forms a weir having a weir height and includes a sand gate. The bulkhead impounds a pool of water to fill the mixing basin at least to the weir height, separating the mixing basin from a sand settling lane vestibule. The impounded water is present to receive a manure payload from the vacuum truck. Water issuing through a flume valve mixes with the received sand-laden manure to form a manure suspension. Water flow through the flume valve is interrupted once a selected volume of water and manure suspension has passed over the weir. Opening the sand gate releases the impounded manure suspension, water and settled sand to flow into the vestibule.

### FIELD OF THE INVENTION

The method and system implicates manure composting technology for dairy barns, specifically conveying sand-free manure to composters.

### BACKGROUND OF THE INVENTION

In the U.S., most large dairy farms operate free stall barns where the cows can move around and choose where to lie down and where they may stand along the feed bunk to eat. Cow comfort is a key ingredient to high milk production and, ultimately, producer profitability. Because, apart from eating, reclining makes up a the greatest part of the cow's day. Thus, finding optimal bedding is a concern of any prudent dairy producer.

Sand remains the free stall bedding of choice among dairy producers and veterinarians. Sand is preferred as it readily conforms to the body of the reclining cow while providing sure footing to the cow when rising from a recumbent posture. Clean sand provides no shelter or food for microbes that might cause disease. The most common component of sand is silicon dioxide in the form of quartz. Quartz is hard, insoluble in water, formed in crystalline structures with flat faces terminating in sharp edges that do not decompose easily from the weathering processes. Such a crystal provides no purchase for microbes. Thus, sand can provide hygienic and comfortable bedding for cattle without providing a host medium for microbes especially as to that scourge of the dairy, the infection of cow teats known as mastitis.

But sand has its shortcomings as well. The hard smooth faces of the crystals meet in hard, sharp edges that will gouge metal from machinery such as pumps. And the crystalline structure also allows sand to slide smoothly along with a flow of water through a dairy allowing it to spread in a pervasive manner allowing it to lodge in or adhere to surfaces in the dairy. Dairy manure, as excreted, contains about 88 percent water some of which is available to spread sand.

To understand the pervasive nature of sand in the operation of the dairy, one must understand how such a dairy is laid out. Each side of a free stall barn has one or more rows of bedded stalls which encourage cows to lie down and rest. Aisles separate the feeding area and rows of stalls. Cows generally will not deposit manure in their bedding, but they will track sand into their manure. Most of the manure is deposited in the aisles. Because cows spend most of their time eating, manure is plentiful. It must be collected at least daily to allow the dairy to function efficiently. But as it resides on the dairy barn floor, the water it contains acts as an agent to spread the sand.

Dairy producers using vacuum tankers have reported a number of benefits over either of scrape or flush dairy operations, including a decrease in flies, suppression of odors, and diminished water use, and have, likewise, noted an increase in herd health and milk production. For example, incidents of hoof disease and mastitis are down while the cows are cleaner and drier. Additionally, cows never have to walk in deep, wet and slippery manure. Additionally, dairy farmers report greater satisfaction because vacuum collection of manure leaves a cleaner work environment.

Even once the manure is collected, it presents a further challenge—disposal. While the volume of sand laden manure produced by any one operation will vary with breed of cattle, level of milk production, sand type, the volume must be dealt with. For example, a Holstein (1400 pounds) cow produces 115 pounds of manure per day or approximately 21 tons per year. In free stall barns, hygiene and safety demand that such a volume of manure be removed from the alleys at least once per day and possibly more often. Manure is moved from alleys using one of three methods: flushing, scraping, or collection in a vacuum tanker. Due to economic and design factors, the vacuum collection of manure is gaining favor among dairy producers.

The vacuum tanker or vacuum truck is a vehicle configured to remove manure from confinement areas much as a powerful vacuum cleaner collects dust in a tank or cannister. Vacuum trucks collect the manure in its densest form, i.e. “as excreted” manure. A popular vacuum truck is, for example, configured to collect approximately 4000 gallons per load. Manure contains both urine and fecal matter, but also, as collected, waste drinking water, waste feed and animal hair and, most significantly, sand. Anything collected that is not organic fiber impairs the utility of the manure as fertilizer. The value of manure as fertilizer is not so high as to offset any significant transportation expense. Sand and water are inert ingredients when used as fertilizer while both are expensive resources which must actually be brought to the dairy to support its operation. Unfortunately, manure contaminated with bedding sand and tracked sand is not concentrated enough to make its nutrients economically viable for transport. Removing sand is necessary in order to make nutrient recovery as fertilizer.

Another good reason to remove sand is its abrasive nature. While sand's abrasive nature allows cows to gain their footing in the free stalls, that same abrasive nature will also prematurely wear pumps and other equipment used for movement and storage of manure within a modern dairy. For the sake of the equipment, the further upstream the sand is removed from manure, the better the for the longevity of the dairy's equipment; the less the machinery is required to move sand laden manure the less the manure exerts wear on that manure handling machinery. Removing the sand from manure at the earliest opportunity preserves machinery, recovers sand and water for reuse, and produces a better manure for downstream processing or transport.

Sand separation must be complete to yield bedding sand. Such sand as may be recovered must be rinsed of fecal matter to serve as good sand bedding. Here too, economics dictates the complete separation of manure and sand so as to recover as much of the sand as possible; that is to recover clean sand. Clean sand is an expensive resource and its recovery is economically desirable. Rinsing with water has proven itself as the most economical means of cleaning sand for reuse because of the hard flat surface of sand granules. But, water, too, is not available in unlimited quantities. Farms are major users of water. In fact, agriculture uses 70% of the fresh water worldwide. A reliable, high quality water supply is essential to dairy farms. Water is used for animal consumption, milk cooling, cleaning and sanitizing equipment, cow cooling, irrigating crops, producing value added products, moving manure and cleaning the barns. In a well-designed system, then, water use must be selective and allow recovery of both bedding sand and rinsing water to take pressure off of drinking water for cattle and reuse of sand for bedding.

What is needed in the industry is a means of receiving manure from vacuum trucks, and recovering the sand and water from the manure in a single economical process or apparatus.

### SUMMARY OF THE INVENTION

An apparatus and a method for receiving sand-laden manure from a vacuum truck in a duty cycle begins by collecting water issuing through a flume valve in a mixing basin. The mixing basin includes a metering bulkhead which forms a weir having a weir height and includes a sand gate. The bulkhead impounds a pool of water to fill the mixing basin at least to the weir height, separating the mixing basin from a sand settling lane vestibule. The impounded water is present to receive a manure payload from the vacuum truck. Water issuing through a flume valve mixes with the received sand-laden manure in the mixing basin to form a manure suspension.

Water and the manure suspension flows over the weir to enter the vestibule while the metering bulkhead continues to impound a volume of the water and the manure suspension behind the metering bulkhead. The flow of water through the flume valve is interrupted once a selected volume of water and manure suspension has passed over the weir. Opening the sand gate releases the impounded manure suspension, water and settled sand to flow into the vestibule. The flow of water through the flume valve is restored to rinse any remaining sand within the mixing basin into the vestibule. The sand gate closes to resume collecting water issuing through the flume valve in the mixing basin thereby to restart a duty cycle.

When diluting the received manure in the mixing basin, in some embodiments, the flush controller initiates the diluting of the received manure by activating a valve to release a flow of water into the mixing basin. The volume used for dilution is a value along with such timing as is necessary to achieve that dilution is retrieved from a look-up table associated with a volume of manure the vacuum truck discharges into the mixing basin. The initiation of that dilution is in response to either activating a control switch or sensing a flow of manure from the vacuum truck with a manure camera focused upon the flow into a receiving basin. When the manure begins to flow from the truck, in a presently preferred embodiment, a pool of water is retained within the mixing basin to enhance mixing and thereby to assist in dilution and to inhibit breeding of flies and propagation of odors.

### BRIEF DESCRIPTION OF THE DRAWINGS

Preferred and alternative examples of the present invention are described in detail below with reference to the following drawings:

FIG. 1 is a plan-view of an exemplary alley vacuum truck dump receptacle having sufficient room to optionally accommodate and receive a discharge from a second vacuum truck;

FIG. 2A is a rear elevation view of a metering bulkhead which retains a pool of water in the mixing basin;

FIG. 2B is a cross-section view of the metering bulkhead which retains a pool of water in the mixing basin;

FIG. 3 is a cross-section view of the exemplary alley vacuum truck dump receptacle along with a vestibule to the sand settling lane;

FIG. 4 is exemplary duty cycle showing timing of a manure dump relative to opening and closing of a sand gate and of a flume valve coordinated with a graph of water level within the mixing basin in operation of the inventive alley vacuum truck dump receptacle;

FIG. 5 is a plan view of the exemplary alley vacuum truck dump receptacle in the larger context of a sand recovery installation yielding clean sand and a manure suspension at a harvest weir;

FIG. 6 is a block diagram of an exemplary flush controller to implement embodiments of the invention; and

FIG. 7 is an exemplary trapezoidal channel depicted for purposes of illustration.

### DETAILED DESCRIPTION OF THE PREFERRED EMBODIMENT

An apparatus and a method for receiving sand-laden manure from a vacuum truck in a duty cycle begins by collecting water issuing through a flume valve in a mixing basin. The mixing basin includes a metering bulkhead which forms a weir having a weir height and includes a sand gate. The bulkhead impounds a pool of water to fill the mixing basin at least to the weir height, separating the mixing basin from a sand settling lane vestibule. The impounded water is present to receive a manure payload from the vacuum truck. Water issuing through a flume valve mixes with the received sand-laden manure to form a manure suspension. Water flow through the flume valve is interrupted once a selected volume of water and manure suspension has passed over the weir. Opening the sand gate releases the impounded manure suspension, water and settled sand to flow into the vestibule.

To condition the manure 1 for later use as fertilizer or feedstock for either of a composter or a digester, it must be made dilute to a concentration that will allow entrained sand to settle out of suspension. But those organic solids that make up the manure in undiluted manure also prevents settling of sand as the organics exhibit colloidal effects in a suspension of manure. For that reason, dilution is necessary to overcome the colloidal effect and, therefore, to separate the sand by settling. Once sufficiently dilute, separation of sand and water is based upon Stokes' law. In particular, there are two parameters, the particle density and the particle radius, that influence how quickly particles will settle. Big particles settle more quickly and denser particles settle more quickly.

Effective separation of sand and organic matter relies upon exploiting a big enough difference between the settling rate of the organic matter in dilute manure and that of the sand entrained in the manure. When properly diluted to overcome the colloidal effect of manure in suspension, organic manure solids settles at one seventh the velocity of sand. Almost all sands have particle densities of right around 2650 kg/m³. The particle size can vary depending on the type of sand present, but typically bedding sand will have a particle size of around 0.25 mm or so, yielding a settling velocity of around 1 m/s. Manure solids have a particle density of closer to 1500 kg/m³ (though it does vary with the amount of fixed and volatile solids in the manure) while the valuable organic dairy manure solids have a geometric mean diameter of around 0.17 mm. Manure exhibits a settling velocity of about 0.14 m/s. So, it is this difference in settling rates that allows sand to be settled out of manure while leaving organic solids in suspension. A current of manure suspension carries organic solids past the settled sand to be harvested as sand-free organic matter. In its harvested state, the organic solids can be used as a raw material for compounding fertilizer or as feedstock for either of a composter or a digester.

Water flowing at velocities greater than one meter, or three feet per second, can entrain sand particles and, in turbulent flows, a sufficient roiling will rinse the sand to yield suitable bedding material. Also, because sufficient water must be added to overcome the colloidal effect of the organics, before the sand can be effectively settled from that manure suspension, the presence of the necessary water might result in particularly suitable digestion feedstock.

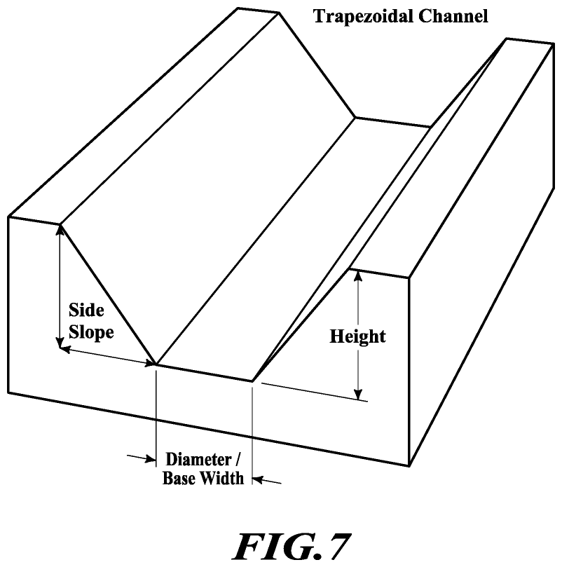

Before discussing the particular workings of the inventive manure receptacle, a consistent understanding of the invention, as the applicant wishes to define a trapezoidal channel in this explanation. As shown in FIG. 7, the term trapezoidal channel shall refer to an open channel with a trapezoidal cross section where both sides have the same side slope. The channel is defined dimensionally with “slope”, “length”, “Manning's number, “diameter” or “base width”, “height”, and “side slope”. Each of the channels set forth in the presently preferred embodiment are trapezoidal channels. Calculation of Manning's equation proves this to be a most effective means of modeling the separating of manure solids from sand in a moving flow of the manure suspension. While Manning's equation is best used for predicting movement of solids in a water column, it can also provide insight into flows of a manure suspension.

Further to the meaning of trapezoidal channel, in presently preferred embodiments of the invention, trapezoidal channels will have a slope. In presently preferred embodiments of the invention, that slope will be approximately one percent (1%). 1% expressed as a decimal is 0.01 and hence the slope of a presently preferred embodiment is 0.01. Traditionally, that expression is referred to as the rise over the run meaning that vertical displacement is divided by the horizontal displacement to express slope. Because of this traditional expression, the slope running downward to the sand extractors is negative along the mixing basin 20. That means for a run of the trapezoidal channel that makes up the mixing basin 20 a given length the floor of the mixing basin 20 must be drop 0.01 times the length. Thus for example, if the length of the mixing basin is 80 feet which is 80×12=960 inches then the floor of the mixing basin must be 0.01×960=9.6 inches lower at the sand gate than at the entry of the water pipe 3.

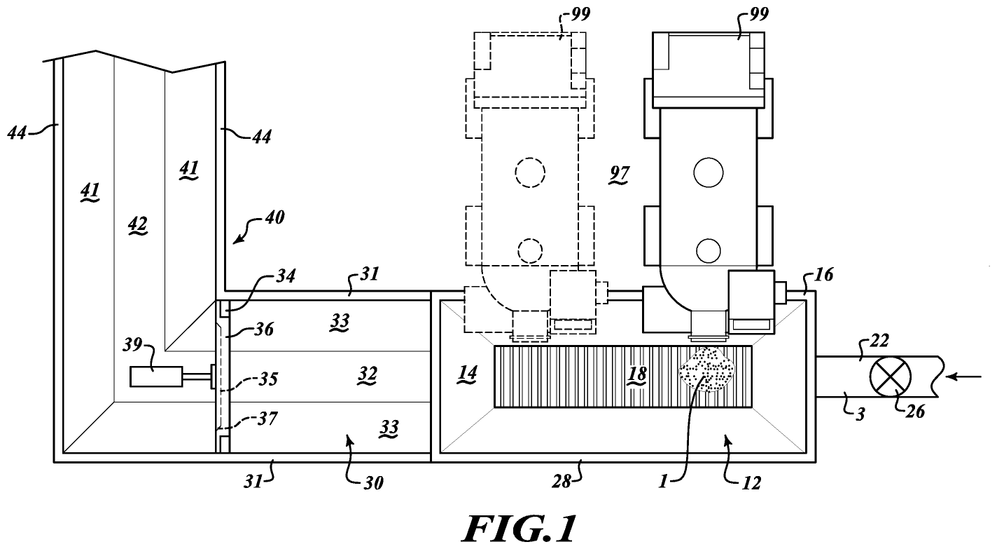

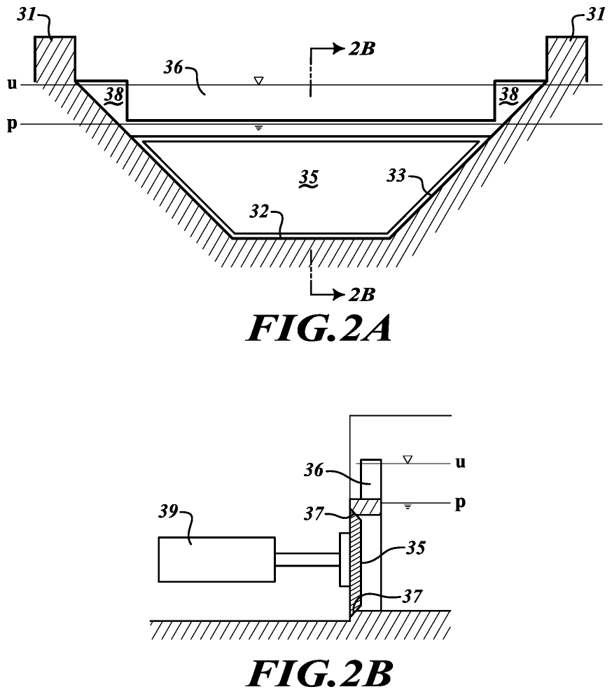

Referring to FIGS. 1, 2, 3 and 5, the mixing basin 20, the sand trap 30 and the vestibule are configured as trapezoidal channels to assure that flow velocities at the natural collection point for sand under the influence of gravity, i.e. the floor of the vestibule 42, the floor of the sand trap 32 and, most importantly, the floor of the mixing basin are configured with side slope, e.g. the vestibule slope 41 and the sand trap slope 33. To prevent eddying pockets in the basins, the geometry of each channel remains constant in cross-section along the length of the channel.

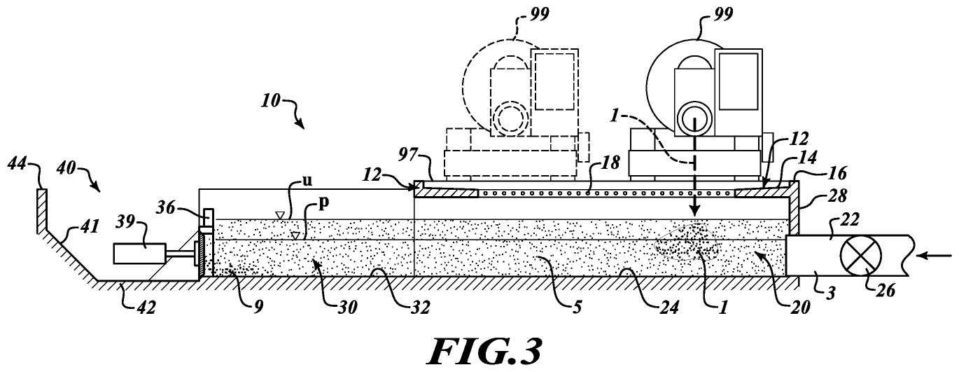

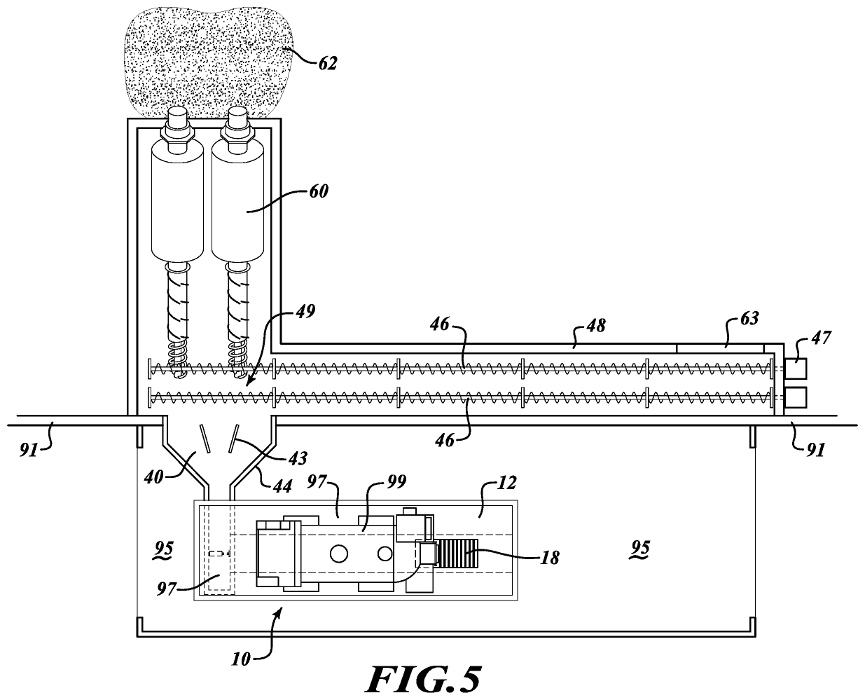

FIGS. 1, 2 and 3 depict in plan views and a cross-sectional views of the inventive alley vacuum dumping receptacle assembly 10 into which the vacuum truck discharges its collected manure 1. It should be noted that in FIGS. 1 and 3, a sand trap 30 is shown as an open basin. That configuration is not the preferred embodiment of the invention though it is, certainly, a viable embodiment of the invention. In the preferred embodiment, however, the sand trap 30 is not a separate structure from the mixing basin 20 and is covered with a cap of precast, prestressed concrete decking. Thus, the preferred embodiment is as shown in FIG. 5 wherein a driveway 95 is situated over what in FIGS. 1 and 3 is set out as the sand trap 30. In the preferred embodiment vacuum trucks 99 may use the driveway 95 to have “drive-through” dumping access to the inventive receptacle assembly 10 such that dumping can occur as vacuum trucks 99 pass over the receiving basin grate 18, thereby allowing multiple vacuum trucks 99 to service a dairy with large numbers of cows.

In one exemplary embodiment, a receptacle assembly 10 includes a shallow receiving basin 12 to receive a flow of manure 1 from the vacuum truck 99. In this exemplary case the receiving basin 12 is made up of four sloping panels 14, each having their respective lip elements 16. The receiving basin 12 is configured to funnel manure 1 issuing from the vacuum truck 99 into a mixing basin residing below a receiving basin grate 18. The receiving basin grate 18 has openings for straining the manure 1 to remove any larger solids such as gloves, hoof parts and large stones from the manure 1. The receiving basin grate 18 is configured to admit only objects of less than a selected radius, in this example, having radii of less than half an inch. Selecting such a radius for separation assures that only suitable bedding material will flow through the receiving basin grate 18 to enter the mixing basin.

Notably, in this explanatory example of a receiving basin 12, lip elements 16 are present on all four sides in order to catch manure 1 and to allow slight backups to collect on top of the receiving basin grate 18 without overflowing the receiving basin 12. Other embodiments are possible within the practice of the instant invention and these elements are only presented for purposes of a clear explanation of the movement of manure 1 into the inventive receptacle 10. For example, in another embodiment, the receiving basin 12 is flush with the deck 97 allowing the use of a stream of water from a hose to drive any spilled manure 1 back into receiving basin grate 18. In any embodiment, the sole purpose of the receiving basin 12 is to receive and strain the manure 1 from the vacuum truck 99 to direct manure 1 through the receiving basin grate 18 and into the mixing basin 20.

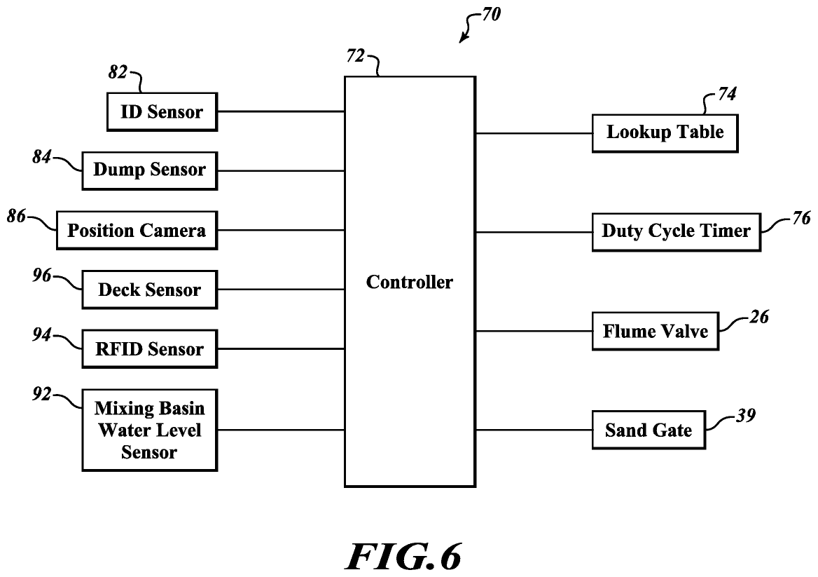

As discussed above, dilution to a particular solid concentration to allow sand settling is an object of the invention. This dilution occurs in the mixing basin 20. The capacity of the various vacuum trucks is known and in a preferred embodiment these values are stored in a lookup table 74 (FIG. 6). For example, in one manufacturer's line of trucks (Mensch Manufacturing™), three models, i.e. the V-2510, the V-3410, and the V-4500 have respective capacities of 2200 gal., 3000 gal., and 4300 gal. Knowing the volume of manure 1 to be emptied in its “as excreted” state, an inventive flush controller 70 can readily calculate a duration necessary for unloading the vacuum truck 99 and allowing the water 3 issuing from a water pipe 22 to roil in the mixing basin 20. To assist in this dilution, in a preferred embodiment, the mixing basin 20 is already filled with water 3 such that the manure 1 will not be allowed to clump or adhere to sides of the mixing basin 20 at the time of the manure dump from the vacuum truck 99.

When the vacuum truck 99 begins to empty its load of manure 1 into the receiving basin 12, as the flume valve 26 continues to release water 3 into the mixing basin 20 from a water pipe 22. The water pipe 22 is configured to direct a high kinetic energy jet of water 3 to meet the manure in the mixing basin 20 and, there, to mix with the manure 1 in sufficient volume to overcome the colloidal effect of the organic fiber in the manure 1. The measured volume of water 3 suitably dilutes the manure 1 to form a sand-laden manure suspension 5 from which sand 9 can settle.

Manure 1 in its “as excreted” state is a suspension of organic material in water. Sand held within such a suspension can remain in suspension for long periods because of strength of attractive forces the manure particulate exhibits known as the colloidal effect. For sand separation to occur, the much more water is added for dilution to allow the sand particles to move past the manure particles and descend unimpeded to the bottom of a water column. Research has shown that for settling out bedding-grade sand, at least two parts of water must be added to one part of sand laden manure by weight. In practice, dilution ratios of 2:1 to 5:1 can be used to achieve separation of sand 9 from dairy manure 1 as excreted. As a result, the higher the dilution rate, the faster and better the sand separation.

Returning, then, to the inventive receptacle assembly portrayed in FIGS. 1, 2 and 3, the mixing basin 20 is the situs of that necessary dilution. As the flush water 3 issues from the flume valve 26 through the water pipe 22 into the mixing basin 20 and as the manure 1 impacts the water 3 flowing over the basin floor 24. The rushing water 3 generates turbulence within the mixing basin 20 which serves to enhance the mixing of issued water 3 with manure 1. The flow of water 3 in the roiling turbulence scrubs smooth faces of the sand granules the manure 1 carries to clean the sand.

As described above, the bulkhead 34 retains a pool of water 3 at a level p to assure that all manure 1 is mixed with the flow of water 3 the flume valve 26 admits into the mixing basin 20 through a pipe 22. This mixing results in a dilute manure suspension 5. A flow of water 3 begins before the manure 1 drops into the mixing basin 20 filled with water 3. The flow of manure suspension 5 continues through the mixing basin 20 into the sand trap 30 and at the far end thereof to carry the dilute manure suspension in a flow 6 over a weir opening the bulkhead defines at the level p behind the metering bulkhead 34.

In his studies of fluid dynamics, Leonardo Da Vinci set forth some principles of fluid motion including the first laws of mass conservation for incompressible flows. Leonardo identified two types of “eddying” motions: one of which is ordered, and one of which is random. Turbulence is usually defined in ways that express it as a random, unpredictable fluid motion. Turbulence is also a dissipative process. That is, by the action of viscosity, the fluctuations in a fluid will tend to be damped out. This means that for a flow to remain turbulent, there must be some external source of energy and some mechanisms for that energy to be fed into the flow. In the mixing basin 20, this energy is supplied by the flow of water 3 through the pipe 22 and into the basin 20.

The metering bulkhead 34 is present to introduce a sheer between the pooled manure suspension 5 pooled behind the metering weir 36 and the flow over the metering weir 36 which may extend to its upper boundary u. Most fluid flows can be conveniently placed into one of two different categories: Laminar or Turbulent. Mixing of mass, momentum, and energy occur much more rapidly in turbulent flows. So, the mixing basin 20 and sand trap 30 together form a single pool for generating and exploiting turbulent flow. The metering weir 36 and the flow it allows enhances turbulence within the mixing basin 20.

As the manure suspension 5 has been urged over the metering weir 36, eddying pockets formed within the pooled manure suspension 5 (having a height of p) allow sand 9 to settle just behind the metering bulkhead 34. After an interval selected by the flush controller 70, the flush controller 70 energizes the sand gate actuator 39 thereby to open the sand gate to release an explosive flow of that impounded manure suspension 5. As the sand gate actuator 39 draws the sand gate face 35 from the sand gate seat 79 manure suspension 5 flows around the sand gate face 35 in an explosive flow, flushing the sand 9 from the mixing basin 20. Optionally, an additional flow of water 3 may issue momentarily from the water pipe 22 when the flush controller 70 opens the flume valve 26 flushing the sand 9 into the sand settling lane vestibule 40. Vestibule distribution vanes 43 direct flushed sand 9 to sand extractors 60 positioned in a sand hopper 49 to harvest the sand 9. This explosive release of the impounded manure suspension 5 defines a duty cycle 50 of the inventive alley vac receptacle 10.

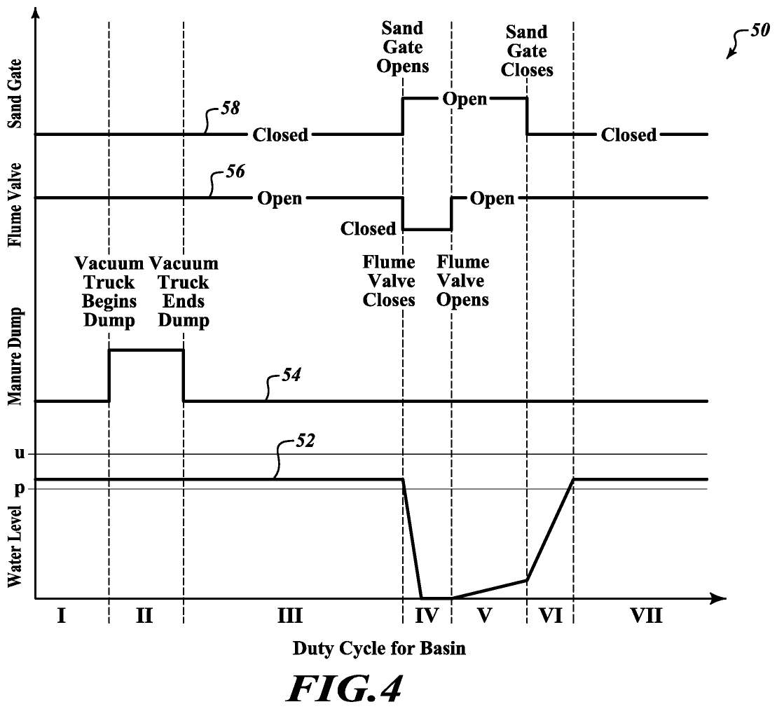

To better understand the use of the sand gate actuator 39, the sand gate face 35 and sand gate seat 37, FIG. 4 depicts the duty cycle 50 of the inventive receptacle assembly 10 showing the water level in the mixing basin 20 as plotted against time on the independent axis. The duty cycle has been arbitrarily commenced prior to the discharge of manure 1 from the vacuum truck 99. Seven intervals sequentially numbered with Roman numerals define the full duty cycle of the inventive receptacle assembly 10, though, in fact, Intervals VII and I are simply identical and simply indicate where the duty cycle 50 repeats itself; they represent an overlap in the execution of the duty cycle 50. Within the presented graph of the duty cycle 50, four curves are presented: the fluid level in the mixing basin 52; the discharge from the vacuum truck 54; the state of the flume valve 56 and the state of the sand gate 58.

In a first interval I, the mixing basin 20 is filled to the level p of the metering weir 36 and overflowing that metering weir 36. In this same first interval I, the water 3 issues from the water pipe 22 into the mixing basin 20 while an equal volume of water 3 cascades over the metering weir 36. As stated above, the manure 3 has not yet issued from the vacuum truck 99 and as such that vacuum tank dump 54 curve shows a “0” value. The flume valve state 56 is open for a value “1” to indicate it allows the above-described flow into the mixing basin 20 issuing from the water pipe 22. Finally, to retain the pooled manure suspension 5 behind the metering bulkhead 34, the sand gate is closed so that the sand gate state 58 is at “0”.

A second interval II initiates when the vacuum truck 99 begins to discharge its payload of manure 1 such that the value of vacuum truck dump 54 has moved from “0” to “1”. The second interval II is bounded by two events that are sensed by a dump sensor 84, the initiation of the dump and its completion as shown by the vacuum tank dump 54 curve. Unlike the other notable events in the duty cycle, these are not initiated by the flush controller 70 but the flush controller 70 synchronizes the duty cycle 50 to these sensed events.

In this second interval II, the sand gates 35 are closed to reflect a sand gate state 56 at “0” and the flume valve 26 remains open such that the flow of water 3 from the water pipe 22 into the mixing basin 20 begins the turbulent mixing of the manure 1 as it leaves the vacuum truck 99. Water 3 continues to flow into the mixing basin 20 roiling the pooled manure suspension 5 while continuing to agitate that manure suspension 5 even as more manure 1 enters the mixing basin 20 as a volume of the manure suspension 5 flows through the metering weir 36.

The third interval III commences when the vacuum truck 99 ends its discharge of manure 1 into the mixing basin 20. Because the flume valve 26 remains open throughout the interval III, the duty cycle 50 reflects the flume valve state 54 remaining at “1” and because water 3 continues to flow into the mixing basin 20 further diluting the manure suspension 5. The ever more dilute manure suspension 5 continues to overflow the metering weir 36. Notably, in the third interval III, the water level 56 continues remain above the level p to continue the mixing even after the end of the discharge of manure 1 from the vacuum truck 99 as indicated the fluid level in mixing basin 52.

The explosive liberation of impounded manure suspension 5 initiates Interval IV as sand gate opens when the sand gate actuator 39 draws the sand gate face 35 from the sand gate seat 37 and the level drops as the manure suspension flows around the sand gate face 35 and this is shown in the drop in fluid level in the mixing basin 52. In a presently preferred embodiment, the flume valve 26 is closed, the flume valve state 56 is thus shown as “0”. In an alternate embodiment, the flume valve 26 closes after the sand gate opens providing a further charge of water to motivate the sand 9 through the sand gate as the manure suspension 5 escapes.

The fifth interval V commences with the reopening of the flume valve 26 while the sand gate remains open. The resulting flow of water 3 from the water pipe 22 sweeps whatever sand remains in any of the mixing basin 20, the sand trap 30, and the sand settling lane vestibule 40 into a sand hopper 49 at the low end of the sand settling lane 45. This sweeping of the trapezoidal channels makes up Interval V as the sand gate state 58 is “1”, the flume valve state 56 is “1” as the fluid level in the mixing basin 52 begins to flow in the then-empty mixing basin 20.

Interval VI begins as the sand gate closes and the mixing basin 20 fills and then overruns the metering weir 36. The marked upward slope of the fluid level in the mixing basin 20 reflects its filling. Because the fluid level in the mixing basin 52 steadily increases until the water level reaches the upper boundary u of the designed capacity of the mixing basin 20, the duty cycle 50 restores itself to its pre-duty cycle state as it is expressed in Interval VII. As stated above, the seventh interval VII and the first interval I are the overlapping ends of the duty cycle 50 and reflect an identical state.

While a first of two alternative situations is illustrated, there is no requirement that the flume valve 26 close at the same moment the sand gate opens though, as illustrated and for discussion purposes, the flume valve state 56 and the sand gate state 58 are depicted in FIG. 4 showing the events as simultaneous. The inventive device can work with equal effectiveness where the opening of the sand gate precedes the closing of the flume valve 26. If practiced in the second alternative embodiment the large volume of the water 3 issuing forth from the water pipe 22 is added to the volume of manure suspension 5 within the mixing basin 20 issues forth through the open sand gate to amplify the explosive liberation of the impounded manure suspension 5. The inventive receptacle assembly 10 will work equally well if the two events were to occur simultaneously or with the opening of the sand gate preceding the closing of the flume valve 26. The fourth interval IV depicts a water level in the mixing basin 52, however, which reflects the first of the embodiments.

As depicted in FIG. 5, just after the manure suspension 5 passes the metering bulkhead 34, it enters a vestibule 40 that conveys it to a sand hopper 49. The sand hopper 49 is a pool where sand 9 in the sand-laden manure slows sufficiently to feed a sand extractor 60. It is an object of the invention to remove and harvest the bedding sand 9 while presenting sand-free manure for harvest, to be used for other purposes such as fertilizer or feedstock for composting or digestion. Vestibule distribution vanes 43 slow and direct the flow of manure suspension 5 and sand 9 within the vestibule 40. One important means of harvesting washed sand 62 is the sand extractor 60, such as the Daritech® One Shot™ sand separation system which, advantageously, lifts, rinses, and stacks quality bedding clean sand 62 for reuse in the dairy.

Thus, immediately past the metering bulkhead, a vestibule 42 spreads and slows the flow of the manure suspension 5 to a flow velocity through the sand hopper 49 and into the sand settling lane 45 at a velocity near 1.25 feet per second. 1.25 feet per second is known as an ideal flow velocity for maintaining the organic matter in the sand laden manure suspension 5 while allowing such sand 9 as flows past the sand hopper 49 to settle in the sand settling lane 45. The vestibule 42 may, optionally, include a concrete block wall, stem wall, or a baffle to further slow the sand laden manure suspension 5. So configured, such a vestibule 42 will provide a desired sheet-like flow into the sand settling lane 40 flowing several feet downstream over the vestibule 42. Manure particles will settle at flow velocities less than 1 foot per second so it is desirable maintain velocity to whisk the manure particles past a sand hopper 49 and the sand settling lane 45 where sand 3 can settle out of the manure suspension 5.

The object, then, of the vestibule 27 is both to regulate the flow of the manure suspension 5 and to load the sand hopper 49 with settled sand while allowing the valuable manure 1 and water 3 to be moved to the far end of a sand settling lane 45 where water 3 can be recycled as flume water 3 and the manure 1 can be harvested for other uses. The trick to separation here is maintaining an average flow velocity through the sand hopper 36 while the vestibule 27 dissipates excessive kinetic energy that might prevent settling of sand 9 into either the sand hopper 49 or the sand settling lane 45. Velocities greater than 3 feet per second are generally too high to allow the settling of sand 9 particles. The vestibule 27 buffers the intermittent flow of the manure suspension 5 as flows through the vestibule 27. Ideally, the vestibule 27 slows the flow to less than three feet per second as the manure suspension 5 exits the vestibule 42 to reach the sand hopper 49 to settle therein.

In the vestibule 40, as well, a plurality (two are illustrated) of sand distribution vanes 43 direct the flow of a sand laden manure suspension 5 to a plurality of sand extractors 60. As the purpose of the sand settling lane 30 is to allow sand and grit to settle while maintaining organic solids flowing in suspension, the flow velocity throughout the sand settling lane 40 must be maintained in the range of 0.75 to 1.25 feet per second. The optimal flow velocity is selected in accord with Manning's equation and as a result the lane width and slope are critical parts of sand settling lane 40 design.

As stated, the sand hopper 49 collects settled sand 9. To do so, the vestibule 40 and vestibule distribution vanes 43 direct a flow of sand laden manure suspension 5 to strike a baffle plate in the sand hopper 49 where it meets the sand settling lane 45. Coarse, heavier sand particulate settles to the bottom of the sand hopper 49, while ultra-fine waste fractions including some remaining sand 9 and, principally, manure 1 particles are carried by the up-current of water into the sand settling lane 45. The sand 9 that enters the sand hopper 49 settles into the funnel-shaped bottom of the sand hopper 49 where an auger conveys that sand 9 into a sand extractor 60.

Within the sand extractor 60, sand and water are augered up a tube inclined at an 18-degree slope toward a discharge end. The rolling and tumbling of the material releases fine organic fiber and some lightweight fractions are rinsed into suspension as water cascades downward to leave at the base. This flow of water also further scrubs organic fiber and superficial clays from the sand surfaces. As the sand is conveyed toward the discharge end, the water begins to separate from the upwardly conveyed sand 62. The sand 62, now cleaned, is shot from the discharge end of the tube where it is stacked for reuse.

What sand 9 is not settled into the base of the sand hopper 49 is carried onward into the sand settling lane 45. Advantageously, the sand settling lane 45 is a long, shallow channel designed to receive the now significantly slowed sand laden manure suspension 5 moving at between 0.75 and 1.25 feet per second. Importantly, the flow velocity moves at less than 1.25 feet per second so that what sand remains in the manure suspension 5 settles in the sand settling lane 45. The flow velocity is slow enough to allow settling while being fast enough to allow the manure to continue in the manure suspension 5 on to a harvest weir 63.

Advantageously, as the manure suspension 5 overflows the harvest weir 63, it is sufficiently dilute as to constitute nearly ideal feedstock for digestion in an anerobic digester. Alternatively, a centrifuge can be used to dewater the manure, supplying flume water for recycling while producing a highly concentrated nutrient mix for use either as composter feedstock or to compound as fertilizer.

At the floor of the sand settling lane 45, two augers 46 receive such sand as settles from the manure suspension 5 at the lower velocity of between 0.75 and 1.25 feet per second. Even fine sand will settle out of the manure suspension 5 as it travels through the sand settling lane 45 rendering clean organic content and water which spills over the harvest weir 63. Meanwhile, the augers 46, in operation, convey the settled sand back into the sand hopper 49 for harvesting through the sand extractors 60 collecting as stacked sand 62.

Moving, then, to FIG. 6, an optional flush controller 90 is presented. While in some embodiments of the invention, the flume valve 26 simply begins a preconfigured duty cycle 50, in response to activation of a deck sensor 96. As such, a dump sensor 84 such as a camera synchronizes the duty cycle 50 relative to the commencement of the dumping from the vacuum truck 99. The first interval I of the duty cycle 50 is a “staging” interval where the pooled water is already present in the mixing basin 20. Such a camera can sense the moment the dumping commences and in response to synchronize the commencement of the second interval II as portrayed in vacuum truck dump 54 shown in FIG. 4. For a vacuum truck 99 of a known volume, the volume of an optimal charge of water 3 for dilution as injected by the flume valve 26 into the mixing basin 20. These embodiments can provide optimal results where a single vacuum truck 99 of a fixed capacity is employed on the dairy. In these embodiments, the optimal charge of water 3 bears a fixed relation to the volume of manure 1 the fully loaded vacuum truck 99 contains. This optimal volume of water 3 is based upon the vacuum truck's 99 full payload volume of vacuumed “as excreted” manure 1 and there is no need for any variability relative to the volume of water 3 to achieve optimal dilution.

In the presently preferred embodiments, however, the flush controller 90 allows for employment of various distinct vacuum trucks 99. To facilitate optimal timing of the commencement of each interval with the duty cycle 50, the flush controller 70 senses the identity of the particular vacuum truck 97 and thus to provide instructions to the flume valve 26 and sand gate timing by matching of various volumes of water 3 to such weight of manure 1 as each vacuum truck 99 might contain thereby to optimally dilute the manure 1 with a suitable volume of water 3. The flush controller 90 in some embodiments includes a deck proximity sensor 96 to indicate positioning of the vacuum truck 99 on the vacuum truck deck 96 as in a dumping posture. Once the vacuum truck 99 is confirmed to be in position, the flush controller 90 then turns on an RFID sensor 94 to determine the identity and, thus, capacity of the vacuum truck. Knowing the identity of the truck 99 allows the flush controller 70 to determine the capacity of the vacuum truck 99 by reference to a lookup table 74 the flush controller 70 includes.

As the vacuum truck 99 moves along a driveway 95 onto the deck 97 to position the vacuum truck 99 over the receiving basin grate 18. A signal from the deck proximity sensor 96 “wakes” the processor 72 in the flush controller 70. The function of the proximity sensor 96 might, optionally, be augmented with the operation of a position camera 86 to assure the vehicle the proximity sensor 96 detects is in a position to allow dumping of the vacuum truck 99. As it progresses through its algorithm, the flush controller 70 may, optionally, inquire of the RFID sensor, the identity of the vacuum truck 99. In alternate embodiments, rather than an RFID sensor, a bar code camera, a near field radio transponder, or any other form of ID sensor 82 that might indicate the identity of the vacuum truck 99. In any embodiment, having knowledge of an identity of the vacuum truck 99, the flush controller 70 will determine the volume of the manure payload the vacuum truck 99 by reference to the lookup table 74. The processor 72, then, understanding the volume and duration of the manure dump, the processor 72 then sets suitable durations of the several intervals II through VII to time the opening and closing of each of the flume valve 26 and, distinctly, of the sand gate by signals to the sand gate actuator 39.

Finally, a dump sensor 84, enabled by such as a camera, radio connection, or, even, a wand sensor, indicates when the vacuum truck 99 begins its emptying of manure 1 into the receptacle assembly 10 to sense the commencement of the second interval II. Once the dump sensor 84 and processor 72 recognize the completion of the emptying flow of manure 1 into the reception basin 12, the processor 72 determines the duration of the third interval III necessary to suitably dilute the discharged manure 1, the flush controller 70 then determines the additional time necessary to suitably dilute the manure suspension 5 as it passes over the metering weir 36. Once suitably diluted, the duty cycle timer 76 indicates the completion of that third interval III.

Upon completion of the third interval III, alternate embodiments of the inventive flush controller 70 allow for distinct events to occur. In a first embodiment, the flush controller 70 simultaneously closes the flume valve 26 and opens the sand gate by energizing the sand gate actuator 39 withdrawing the sand gate face 35 from engagement with the sand gate seat 37, thereby, commencing the fourth interval IV. During this fourth interval IV, the flush controller 70 releases all of the impounded manure suspension 5 from behind the metering bulkhead 34 with explosive force, thereby draining the mixing basin 20. In the alternate embodiments, the flush controller first opens the sand gate while the flush controller 70 holds the flume valve 26 open for a predetermined interval. Once the sand gate is open and the flume valve 26 are closed, a further predetermined pause, selected to allow the draining of the mixing basin 20. In either embodiment, the flush controller 70 may, optionally, confirm each of the intervals I-VII using a mixing basin fluid level sensor 92 by comparing actual to sensed levels in the mixing basin 20.

To commence the fifth interval V, the flush controller 70 activates the flume valve 26 to release the appropriate volume of water as to urge all of the settled sand 9 through the open sand gate and past the metering bulkhead 34 down the vestibule 40 and, ultimately, into the sand hopper 49. Upon the completion of a predetermined flush interval, the flush controller 70 closes the sand gate and because in all embodiments, the flume valve is open, water rapidly fills the mixing basin 20 to overflow the metering weir 36, thus completing the sixth interval VI. In the seventh interval VII, the device has reached a staged state identical to the state in the first interval I.

As set forth, herein, the inventive receptacle assembly 10, thus operates to deliver sand to the sand extractor 60 and a dilute suspension of manure 3 and water 1 to the harvest weir 63 for movement to the appropriate mechanism for using the harvested manure by any of centrifugation, composting, or digestion. Advantageously, digestion requires dilution of manure and, as harvested at the harvest weir 63, the manure is in a suitable state for digestion.

The embodiments of the invention in which an exclusive property or privilege is claimed are defined as follows:

1. A method for receiving sand-laden manure from a vacuum truck, the method comprising:
commencing a duty cycle by collecting water issuing through a flume valve in a mixing basin, the mixing basin being defined by walls and a metering bulkhead, the metering bulkhead defining a weir having a weir height and further defining a sand gate, the collecting to impound a pool of water to fill the mixing basin at least to the weir height, the metering bulkhead situated to separate the mixing basin from a sand settling lane vestibule;
receiving a manure payload from the vacuum truck within the mixing basin such that the water issuing through the flume valve mixes water with the received sand-laden manure in the mixing basin to produce a manure suspension, the manure suspension being sufficiently dilute to allow some sand to settle from such volume of the manure suspension impounded behind the metering bulkhead;
allowing such of the water and the manure suspension to flow over the weir, the water and manure suspension originating from within the mixing basin and entering the vestibule while the metering bulkhead continues to impound, beneath the weir height, a volume of the water and the manure suspension behind the metering bulkhead;
interrupting the flow of water through the flume valve once a selected volume of water and manure suspension has passed over the weir;
opening the sand gate the metering bulkhead defines to release the impounded manure suspension, water and settled sand into the vestibule from behind the metering bulkhead into the vestibule;
restoring the flow of water through the flume valve to rinse any remaining sand within the mixing basin into the vestibule; and
closing the sand gate to resume collecting water issuing through the flume valve in the mixing basin thereby to restart a duty cycle.

2. The method of claim 1 further comprising:
receiving in the vestibule from the mixing basin a fluid flow, the fluid flow including water and at least one of a group comprising manure suspension and sand.

3. The method of claim 1 further comprising:
receiving the fluid flow from the vestibule, the fluid flow passing through a sand hopper and receiving the fluid flow in a sand settling lane at a sand settling lane entrance;
receiving sand settling from the fluid flow in the sand hopper, the sand hopper funneling sand into a sand extractor washing, lifting, and ejecting received sand by operation of the sand extractor.

4. The method of claim 3 wherein “receiving the fluid flow from the vestibule, the fluid flow passing through a sand hopper and receiving the fluid flow in a sand settling lane” includes:
receiving the fluid flow from mixing basin at the vestibule at a flow velocity in excess of about three feet per second; and
receiving the fluid flow in a sand settling lane at less than 1.25 feet per second.

5. The method of claim 2 wherein the vestibule includes at least one vane, each vane to direct the fluid flow to one of a plurality of sand extractors.

6. The method of claim 3 wherein the “receiving the fluid flow in a sand settling lane” includes:
receiving sand settling from the fluid in the sand settling lane in a sand settling lane floor extending along the sand settling lane and terminating at the sand hopper; and
rotating the sand conveying auger to convey received sand to the sand hopper.

7. The method of claim 1 further comprising:
receiving the fluid flow at a sand settling lane harvest weir, the fluid flow consisting, substantially, of manure solids and water, the sand having settled from the fluid flow into the sand hopper or sand settling lane.

8. An apparatus for receiving a manure payload from a vacuum truck, the apparatus comprising:
a flume valve mounted on a water pipe, the flume valve being configured to selectively interrupt a flow of water into a mixing basin;
the mixing basin being defined by walls and a metering bulkhead;
the metering bulkhead being situated to separate the mixing basin from a sand settling lane vestibule and, further, defining:
a weir having a weir height; and
a sand gate configured to selectively open and close, when closed, the sand gate is configured to impound a pool of water to fill the mixing basin at least to the weir height;
the sand settling lane vestibule; and
a flush controller including:
a manure flow sensor to sense the release of manure from the vacuum truck; and
a duty cycle timer to initiate each of six distinct intervals within a duty cycle, the six intervals commencing, in turn by:
sensing an initiation of the release of manure from the vacuum truck;
sensing a completion of the release of manure from the vacuum truck;
closing the flume valve to interrupt the flow of water into the mixing basin;
opening the sand gate to allow release of impounded pool manure suspension;
opening the flume valve to resume the flow of water into the mixing basin; and
closing the sand gate to collect water issuing through the flume valve to pool in the mixing basin.

9. The apparatus of claim 8 further comprising:
a sand hopper, the sand hopper being connected to:
the vestibule so as to receive a fluid flow from the mixing basin, the fluid flow having a velocity being generally in excess of three feet per second as it leaves the mixing basin, the sand hopper narrowing downward to funnel sand into a connected sand extractor, the sand extractor configured to wash, lift, and eject and sand received from the sand hopper; and
a sand settling lane to receive a fluid flow from sand hopper, the fluid flow within the sand settling lane being less than 1.25 feet per second.

10. The apparatus of claim 9 wherein the vestibule includes features to slow the fluid flow from the vestibule at a vestibule exit fluid flow velocity to a sand settling lane fluid flow velocity.

11. The apparatus of claim 10 wherein the vestibule further includes vanes each to direct the fluid flow at one of a plurality of sand extractors.

12. The apparatus of claim 9 wherein the sand settling lane includes:
a sand conveying auger situated at a sand settling lane floor extending along the sand settling lane and terminating at the sand hopper; and
a motor for rotating the sand conveying auger to convey received sand to the sand hopper.

13. The apparatus of claim 10 wherein the sand settling lane defines a sand settling lane harvest weir in opposed relation to the sand hopper, the sand settling harvest weir located to allow the flow of manure solids and water thereover, the sand having settled from the fluid flow into the sand hopper or sand settling lane.

14. The apparatus of claim 8 wherein the flush controller further includes:
a deck proximity sensor to sense a presence of the vacuum truck in a position to discharge the payload of manure into the mixing basin.

15. The apparatus of claim 8 wherein the flush controller further includes:
an truck ID sensor to determine the identity of the vacuum truck in a position to discharge the payload of manure into the mixing basin; and
a lookup table to determine a payload volume based upon the sensed identity of the vacuum truck received from the truck ID sensor.

16. The apparatus of claim 8 wherein the flush controller further includes:
a sensor to determine a fluid level present in the mixing basin.

17. A flush controller for controlling a flume valve and a sand gate in a mixing basin for receiving a payload of manure from a vacuum truck, the flush controller including:
a manure flow sensor to sense the release of manure from the vacuum truck; and
a duty cycle timer to initiate each of six distinct intervals within a duty cycle, the six intervals commencing, in turn by:
sensing an initiation of the release of manure from the vacuum truck;
sensing a completion of the release of manure from the vacuum truck;
closing the flume valve to interrupt the flow of water into the mixing basin;
opening the sand gate to allow release of impounded pool manure suspension;
opening the flume valve to resume the flow of water into the mixing basin; and
closing the sand gate to collect water issuing through the flume valve to pool in the mixing basin.

18. The flush controller of claim 17 which further includes:
a deck proximity sensor to sense a presence of the vacuum truck in a position to discharge the payload of manure into the mixing basin.

19. The flush controller of claim 17 which further includes:
an truck ID sensor to determine the identity of the vacuum truck in a position to discharge the payload of manure into the mixing basin; and
a lookup table to determine a payload volume based upon the sensed identity of the vacuum truck received from the truck ID sensor.

20. The flush controller of claim 17 which further includes:
a sensor to determine a fluid level present in the mixing basin.
